(19) United States
(12) Patent Application Publication
(10) Pub. No.: US 2026/0208415 A1
(43) Pub. Date: Jul. 23, 2026

(54) SHUT-OFF NOZZLE FOR INJECTION MOLDING

(71) Applicant: Moxietec, LLC, Grove City, PA (US)

(72) Inventors: Abolfazi Mohebbi, Mississauga (CA); Nathan David Albensi, Meadville, PA (US); Robert Alan Sickles, JR., Carlton, PA (US); Glen Robert Thomas, Pulaski, PA (US); Andrew James Tempalski, Hookstown, PA (US)

(73) Assignee: Moxietec, LLC, Grove City, PA (US)

(21) Appl. No.: 19/569,996

(22) Filed: Mar. 17, 2026

Related U.S. Application Data
(63) Continuation-in-part of application No. 19/290,041, filed on Aug. 4, 2025.
Application No. 19/290,041 is a continuation of application No. 19/041,305, filed on Jan. 30, 2025, now Pat. No. 12,377,587.
Application No. 19/041,305 is a continuation of application No. 18/640,747, filed on Apr. 19, 2024, now Pat. No. 12,275,175.
(60) Provisional application No. 63/594,652, filed on Oct. 31, 2023.
(60) Provisional application No. 63/773,404, filed on Mar. 17, 2025.
(60) Provisional application No. 63/894,951, filed on Oct. 7, 2025.

(51) Int. Cl. B29C 45/23; B29C 45/72; B29C 45/78

(52) U.S. Cl. CPC B29C 45/231; B29C 45/72; B29C 45/78; B29C 2945/7604; B29C 2945/7621; B29C 2945/76531; B29C 2945/76688

(57) ABSTRACT

Disclosed herein are novel shut-off nozzles for injection molding systems for creating and injecting foaming polymers to form molded polymer products. In one embodiment, a shut-off nozzle includes a main body with a flow path, a connector body securable to the main body, a nozzle tip securable to the main body, and a shut-off mechanism. The nozzle tip includes an internal passage and a cooling mechanism for solidifying molten polymer in the nozzle tip at an end of an injection cycle of an injection molding process such that the solidified polymer in the nozzle tip is joined with a formed polymer part. When the main body and nozzle tip are secured together the flow path is colinear with the internal passage. The shut-off mechanism includes a passageway intersecting the flow path at an angle to the flow path and a pin positioned in the passageway.

### CROSS-REFERENCE TO RELATED APPLICATIONS

The present application is a continuation-in-part of U.S. patent application Ser. No. 19/290,041, titled “Shut-Off Nozzle for Injection Molding, filed on Aug. 4, 2025, which is a continuation of U.S. patent application Ser. No. 19/041,305, titled “Shut-Off Nozzle for Injection Molding,” filed Jan. 30, 2025, which is a continuation of U.S. patent application Ser. No. 18/640,747, titled “Shut-Off Nozzle for Injection Molding,” filed Apr. 19, 2024, and claims priority to U.S. Provisional Application Ser. No. 63/594,652, titled “Shut-Off Nozzle for Injection Molding,” filed Oct. 31, 2023. The present application further claims priority to U.S. Provisional Application Ser. No. 63/773,404, titled “Shut-Off Nozzle for Injection Molding,” filed Mar. 17, 2025 and U.S. Provisional Application Ser. No. 63/894,951, titled “Shut-Off Nozzle for Injection Molding,” filed Oct. 7, 2025. All the foregoing applications are fully hereby incorporated by reference herein.

### FIELD OF INVENTION

The present disclosure generally relates to methods of using a shut-off nozzle with injection molding machines and injection molding processes. More specifically, the present disclosure relates to an efficient shut-off nozzle for injection molding of polymers to form components and parts with precise dimensions and unmarred surfaces.

### BACKGROUND

Injection molding systems and processes are useful in manufacturing plastic products, parts, and components. A typical injection molding system includes an injection molding machine and a mold. The injection molding machine includes a barrel, a reciprocating screw located at least in part in the barrel, heating elements to heat the barrel, and a nozzle extending from the end of the barrel. The mold includes a cavity shaped to form the desired product, part, or component. The injection molding process begins by providing a source of solid polymer, such as polymer pellets, to the reciprocating screw, which introduces the polymer into the barrel. Through a combination of shear stresses applied by the reciprocating screw and heat applied by the heating element to the barrel, the polymer pellets melt to form a molten polymer that can flow through the barrel. The tip of the nozzle is placed proximate to an opening in the mold that leads to the cavity of the mold, as the reciprocating screw turns, the molten polymer flows out of the nozzle and into the cavity of the mold until the cavity is filled. Once the cavity is filled, the flow of molten polymer ceases. With the cavity is filled, the mold is cooled until the polymer solidifies to form the desired product, part, or component. The product, part, or component is then ejected or otherwise removed from the cavity, and the process is repeated to form another product, part, or component. The injection molding process that forms each product, part, or component is referred to as a cycle. It will be understood that while the process is described as each cycle forming a single product, part, or component, a mold and cavity can be arranged to form more than one product, part, or component in each cycle. While the basic injection molding process appears fairly straightforward, the varying nature of different polymers and the challenge of controlling the viscosity and flow of such varying polymers requires precise methods and environmental parameters to create a repeatable injection molding process.

For example, if a specific polymer forms a high viscous molten polymer when heated and sheared, the molten polymer can be injected into the mold using a simple open-channel nozzle without any specific resistance. Because of its high viscosity, when the flow of the polymer ceases at the end of each cycle, it is less likely to continue to flow out of the nozzle. However, if a polymer has a low viscosity in its molten state, at the conclusion of each cycle of the injection process, when the system intends the flow of the polymer to cease, molten polymer may continue to flow and leak from the tip of the nozzle (commonly referred to as “drool” or “drooling”). Such drooling results in unfavorable flashing and requires frequent cleaning by an operator, which slows down the injection molding process and causes inefficiencies. These issues are particularly problematic when molding products, parts, or components from polymer foams.

Using polymer foam in the injection molding process adds complexity to the process. A foam injection process as compared to standard solid injection process is more sensitive to environmental parameters and poses challenges regarding flow control through prior art shut-off nozzles. Such prior art shut-off nozzles have disadvantages and are not readily suitable for the foam injection process. In particular, prior art nozzles pose significant challenges once the molten polymer is saturated with gases (i.e., foamed). As an initial matter, when a molten polymer is saturated with gases introduced by a blowing agent, the melt flow index (MFI) of the polymer is very high, causing significant drooling issues in the injection molding process. Additionally, such a gas saturated molten polymer must be carefully managed to create more efficient nucleation and a higher pressure drop rate, which results in a higher expansion of the polymer entering the mold and cavity and produces a more uniform cellular structure for the final product, part, or component.

Prior art shut-off nozzles used with foaming polymers are problematic and result in excessive drooling and inconsistent final products, parts, and components. FIG. 1 illustrates such a prior art shut-off nozzle 10. The shut-off nozzle 10 includes a shut-off mechanism 20, which is typically positioned perpendicular to the direction of molten polymer flow through the system. In the example of FIG. 1, a shut-off mechanism 20 includes a pin (also commonly referred to as a needle) 30 that is selectively actuated to stop the flow of polymer through a flow path 40 of the shut-off nozzle 10. The pin 30 is positioned in a passageway 50 that intersects a flow path 40 at a right angle. As illustrated in the enhanced image FIG. 1A, the flow path 40 near where it intersects the passageway 50 is not consistent in diameter. As polymer flows through the flow path 40, the diameter of the flow path 40 is first rapidly stepped down as the polymer nears the passageway 50, thus rapidly decreasing the diameter of the flow path 40. The diameter is then rapidly stepped up as the polymer moves away from the passageway 50, thus rapidly increasing the diameter of the flow path 40. These changes in the diameter of the flow path 40 are designed to reduce the diameter at the point where the pin 30 intersects the flow path 40 to make it easier for the pin 30 to stop the flow of molten polymers through the flow path 40. However, the reduction in diameter of the flow path 40 leading to the intersection with the passageway 50 and the expansion in diameter after the intersection with the passageway 50 are highly detrimental to the quality and amount of foaming experienced by the molten polymer. These rapid changes in diameter can cause early and inefficient cell nucleation and formation in the molten polymer, which ultimately results in less weight reduction and inconsistent cell morphology in the final molded product, part, or component.

Referring again to FIG. 1, when the pin 30 is in a retracted position, the polymer is free to follow through the flow path 40 of the shut-off nozzle 10, out of a nozzle tip 60, and into the awaiting cavity of the mold. When the pin 30 is actuated, the pin 30 moves upward (relative to FIG. 1) so that it is positioned in the flow path 40, blocks the flow path 40, and stops the flow of polymer through the flow path 40. In such a prior art machine 10, the distance (D₁) between the location where the pin 30 of the shut-off mechanism 20 engages the flow path 40 to stop the flow of polymer and the end of the nozzle tip 60 is significant. This results in a significant volume of molten polymer positioned between the pin 30 and the end of the nozzle tip 60 at the end of every cycle. When the injection cycle ends, the mold is cooled to solidify the molded component, part, or component in the cavity. However, the large volume of polymer left in the shut-off nozzle 10 between the pin 30 and the end of the nozzle tip 60 typically only partially solidifies between cycles. This makes it difficult to eject this remaining polymer and results in unwanted flashing and excessive drooling, which unnecessarily affects the next molded product, part, or component and often causes interruptions in the injection molding process due to stop the process and to clean the nozzle tip 60.

This disclosure describes novel shut-off nozzles for use with injection molding systems and processes, particularly for use with foam injection molding of polymers, that address the issues with prior art shut-off nozzles and result in significantly more control of the injection molding process and result in superior final molded products, parts, and components.

### SUMMARY

Disclosed herein are embodiments of novel shut-off nozzles for use with an injection molding system for creating and injecting foaming polymers into a mold with a cavity to form products, parts, and other components. The shut-off nozzles are designed to increase cell nucleation during the foaming process, increase the pressure drop rate as the polymer is injected into a mold and cavity, and prevent drooling of the foamed polymer at the end of an injection cycle. The shut-off nozzles include a novel shut-off mechanism with an angled shut-off pin, which significantly reduces the amount of waste in each injection cycle, and a novel nozzle tip with a cooling mechanism with a fluid-cooling circuit to rapidly cool and solidify the molten polymer remaining near the end of the shut-off nozzle at the conclusion of each injection cycle.

In one embodiment, a shut-off nozzle for an injection molding process to form a polymer product, part, or component includes a main body; a connector body arranged to be secured to a first end of the main body; a nozzle tip arranged to be secured to a second and opposite end of the main body; and a shut-off mechanism. The main body includes a flow path through the main body. The nozzle tip includes an internal passage and a cooling mechanism. The internal passage of the nozzle tip is colinear with the flow path of the main body when the nozzle tip is secured to the main body. The cooling mechanism is arranged to solidify molten polymer in the internal passage of the nozzle tip at an end of an injection cycle of an injection molding process. The shut-off mechanism includes a passageway intersecting the flow path of the main body at an angle to the flow path; and a pin positioned in the passageway.

In another embodiment, a shut-off nozzle for an injection molding process to form a polymer product, part, or component includes a main body, a connector body securable to a first end of the main body, a nozzle tip securable to a second and opposite end of the main body, and a shut-off mechanism. The main body includes a flow path through the main body. The nozzle tip includes a flange for securing the nozzle tip to the second end of the main body. The shut-off mechanism includes a passageway intersecting the flow path at an angle to the flow path and a pin positioned in the passageway, where the pin can be moved between at least two positions. A first position of the pin prevents polymer from flowing through the flow path and a second position of the pin allows polymer to flow through the flow path.

In another embodiment, a shut-off nozzle includes a main body and a nozzle tip securable to an end of the main body. The shut-off nozzle includes a flow path through the main body and the nozzle tip includes an internal passage through the nozzle tip, wherein the flow path and the internal passage are colinear when the nozzle tip is secured to the main body. The nozzle tip further includes a cooling mechanism. The cooling mechanism includes a helix circuit positioned around the internal passage through the nozzle tip and arranged to accept the flow of a cooling fluid through the helix circuit. As cooling fluid flows through the helix circuit, heat from molten polymer in the internal passage of the nozzle tip is transferred to the cooling fluid such that the molten polymer in the internal passage of the nozzle tip will solidify. Additionally, when heat is transferred from the molten polymer in the internal passage of the nozzle tip to the cooling fluid flowing through the helix circuit, any molten polymer in the flow path proximate to the nozzle tip will also solidify. When molten polymer in the internal passage and flow path solidifies, the solidified polymer can be ejected from the shut-off nozzle as one continuous piece.

In another embodiment, a method for forming a polymer product, part, or component includes the step of providing an injection molding system with a shut-off nozzle, where the shut-off nozzle includes a main body, a nozzle tip secured to the main body, and a shut-off mechanism. The main body includes a flow path through the main body and the nozzle tip includes an internal path through the nozzle tip, where the flow path and internal passage are colinear when the nozzle tip is secured to the main body. The nozzle tip further includes a cooling mechanism. The shut-off mechanism includes a passageway intersecting the flow path at an angle to the flow path and a pin positioned in the passageway. The method further includes the steps of initiating an injection molding cycle by injecting molten polymer through the shut-off nozzle into a mold with a cavity until a cavity of the mold is filled with molten polymer, actuating the shut-off mechanism to move the pin in the passageway into the intersection of the passageway and flow path, and initiating the cooling mechanism to solidify molten polymer in the nozzle tip to form a solid slug. Optionally, the method described above can further include the step of cooling the molten polymer in the cavity of the mold to solidify the molten polymer in the cavity of the mold to form a polymer product, part, or component. The step of initiating the cooling mechanism to solidify molten polymer in the nozzle tip to form a solid slug and the step of cooling the molten polymer in the cavity of the mold to solidify the molten polymer in the cavity of the mold to form a polymer part may occur at the same time. After the step of initiating the cooling mechanism to solidify molten polymer in the nozzle tip to form a solid slug and the step of cooling the molten polymer in the cavity of the mold to solidify the molten polymer in the cavity of the mold to form a polymer product, part, or component are completed, the cold slug and formed polymer product, part, or component may be physically connected, where the formed polymer product, part, or component from the cavity in the mold and the solid slug from the nozzle tip can be ejected together from the injection molding system.

### BRIEF DESCRIPTION OF THE DRAWINGS

In the accompanying drawings, structures are illustrated that, together with the detailed description provided below, describe example embodiments of the disclosed systems, methods, and apparatus. Where appropriate, like elements are identified with the same or similar reference numerals. Elements shown as a single component can be replaced with multiple components. Elements shown as multiple components can be replaced with a single component. The drawings may not be to scale. The proportion of certain elements may be exaggerated for the purpose of illustration.

FIG. 1 schematically illustrates a cross-sectional view of a prior art shut-off nozzle.

FIG. 1A is an enhanced view of the flow path of the prior art shut-off nozzle of FIG. 1 illustrating the flow path near the passageway of the shut-off nozzle.

FIG. 2 is a photograph of a molded article formed by an injection molding machine with a prior art shut-off nozzle.

FIG. 3 schematically illustrates a perspective view of an exemplary embodiment of a shut-off nozzle for use with an injection molding machine.

FIG. 4 schematically illustrates a perspective view of the shut-off nozzle of FIG. 3 with transparent sections revealing internal mechanisms.

FIG. 5 schematically illustrates a cross-sectional side view of the shut-off nozzle of FIG. 3.

FIG. 6 schematically illustrates another cross-sectional view of the shut-off nozzle of FIG. 3.

FIG. 7 schematically illustrates a side view of the shut-off nozzle of FIG. 3 with a transparent section revealing a shut-off mechanism.

FIG. 8 schematically illustrates the identified section of FIG. 7.

FIG. 9 schematically illustrates the identified section of FIG. 7.

FIG. 10 schematically illustrates a cross-section view of the engagement of the pin and drive plate of the shut-off nozzle of FIG. 3.

FIG. 11 schematically illustrates another view of the engagement of the pin and drive plate of the shut-off nozzle of FIG. 3.

FIG. 12 schematically illustrates an exploded view of the pin and drive plate of the shut-off nozzle of FIG. 3.

FIG. 13 schematically illustrates another exploded view of the pin and drive plate of the shut-off nozzle of FIG. 3.

FIG. 14 schematically illustrates a cross-sectional view of the shut-off mechanism in a retracted position.

FIG. 15 schematically illustrates a cross-sectional view of the shut-off mechanism in an actuated position.

FIG. 16 schematically illustrates a perspective view of a nozzle tip with a helical cooling system.

FIG. 17 schematically illustrates another perspective view of a nozzle tip with a helical cooling system.

FIG. 18 schematically illustrates the nozzle tip of FIG. 16 with a transparent section showing the helical cooling system.

FIG. 19 schematically illustrates a cross-sectional view of the nozzle tip of FIG. 16 with a large central passageway.

FIG. 20 is a photograph of an article formed by an injection molding machine with the shut-off nozzle as described herein, with the sprue remaining intact with the article.

FIG. 20A is an enhanced view of the tip of the sprue of FIG. 20.

FIG. 21 schematically illustrates a perspective view of another exemplary embodiment of a shut-off nozzle for use with an injection molding machine.

FIG. 22 schematically illustrates another perspective view of the shut-off nozzle of FIG. 21.

FIG. 23 schematically illustrates a side view of the shut-off nozzle of FIG. 21.

FIG. 24 schematically illustrates another side view of the shut-off nozzle of FIG. 21

FIG. 25 schematically illustrates a rear view of the shut-off nozzle of FIG. 21.

FIG. 26 schematically illustrates a perspective exploded view of the shut-off nozzle of FIG. 21.

FIG. 27 schematically illustrates cross-sectional side view of the shut-off nozzle of FIG. 21.

FIG. 28 schematically illustrates another cross-sectional side view of the shut-off nozzle of FIG. 21.

FIG. 29 schematically illustrates an enhanced view of the nozzle tip of the shut-off nozzle of FIG. 21.

FIG. 30 schematically illustrates cross-sectional view of the nozzle tip of the shut-off nozzle of FIG. 21.

FIG. 31 schematically illustrates a perspective view of a two-piece nozzle tip assembly.

FIG. 32 schematically illustrates an exploded view of the two-piece nozzle tip assembly of FIG. 31.

FIG. 33 schematically illustrates a cross-sectional view of the two-piece nozzle tip assembly of FIG. 31.

FIG. 34 schematically illustrates a perspective view of an extended two-piece nozzle tip assembly.

FIG. 35 schematically illustrates an exploded view of the extended two-piece nozzle tip assembly of FIG. 34.

FIG. 36 schematically illustrates a cross-sectional view of the extended two-piece nozzle tip assembly of FIG. 34.

### DETAILED DESCRIPTION

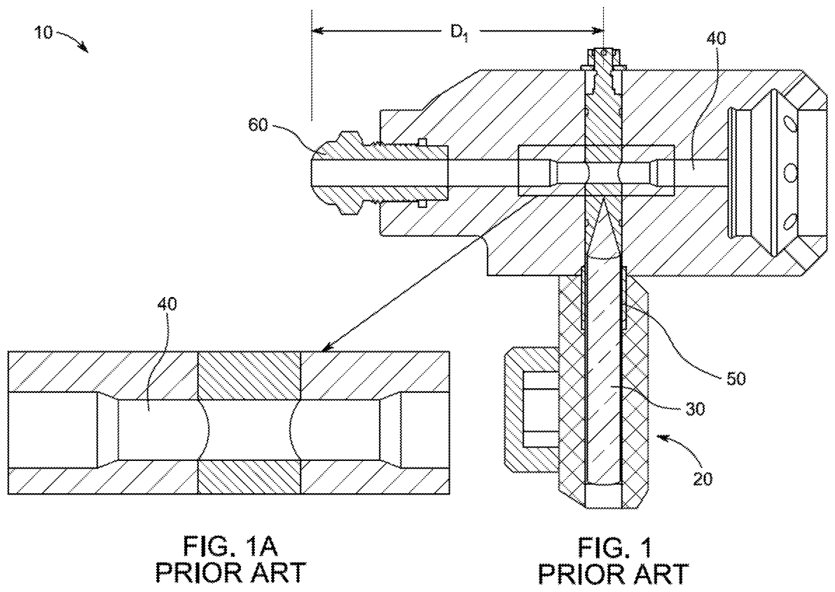

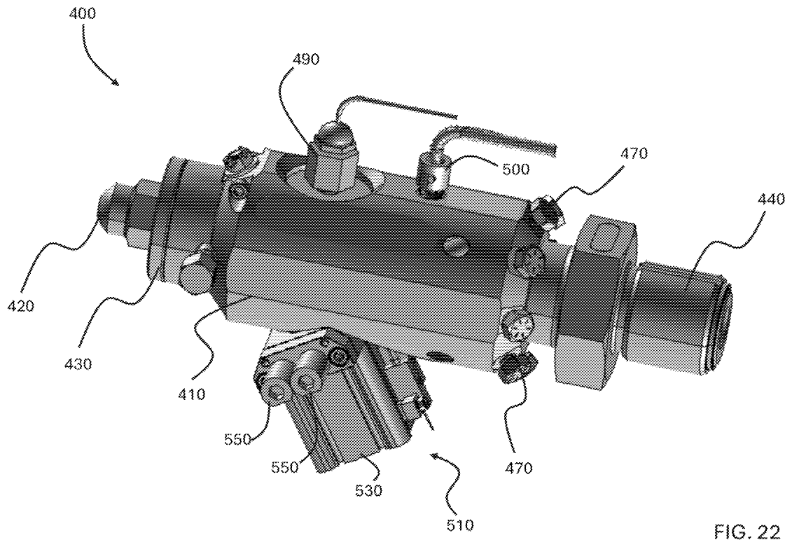

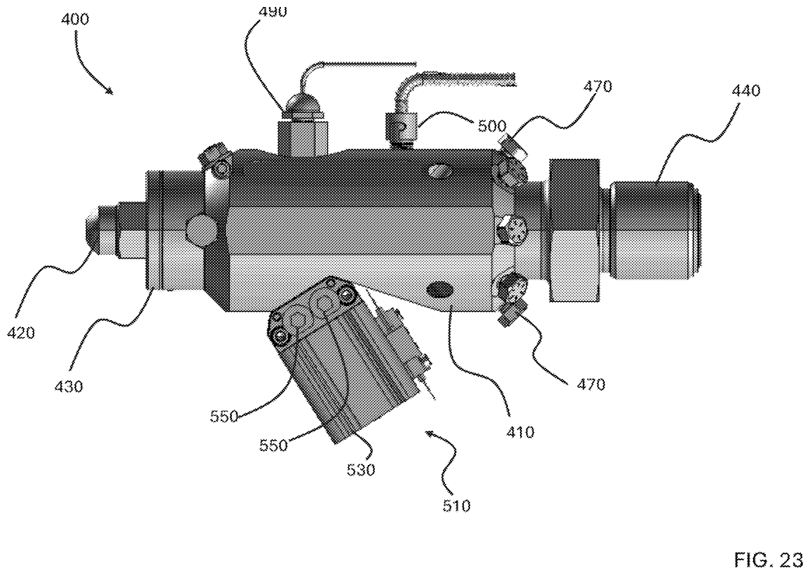

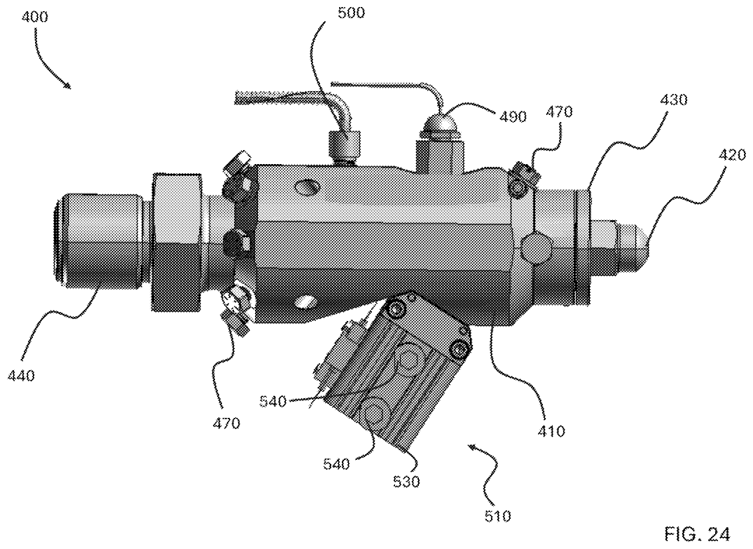

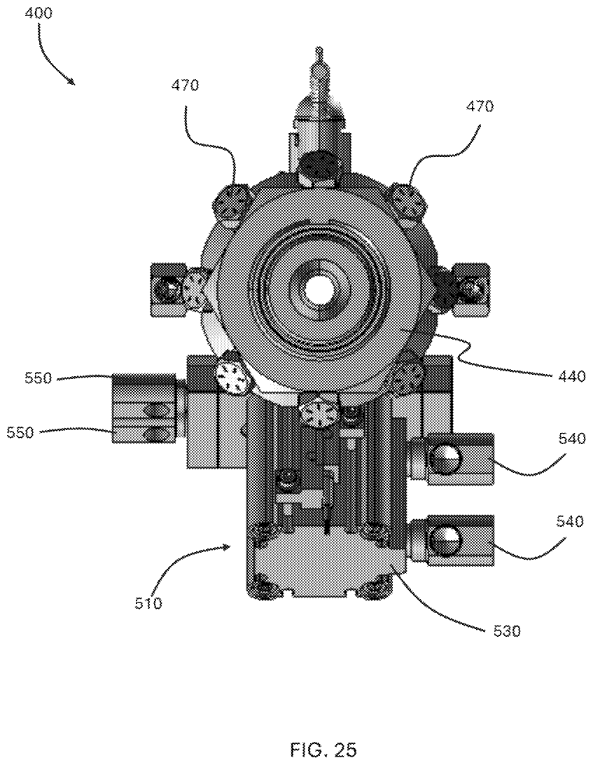

The apparatus, systems, arrangements, and methods disclosed in this document are described in detail by way of examples and with reference to the figures. It will be appreciated that modifications to disclosed and described examples, arrangements, configurations, components, elements, apparatus, methods, materials, etc. can be made and may be desired for a specific application. In this disclosure, any identification of specific techniques, arrangements, method, etc. are either related to a specific example presented or are merely a general description of such a technique, arrangement, method, etc. Identifications of specific details or examples are not intended to be and should not be construed as mandatory or limiting unless specifically designated as such. Selected examples of shut-off nozzles for use in injection molding processes forming products and components from foamed polymers are hereinafter disclosed and described in detail with reference made to FIGS. 1 through 36.

Disclosed herein is a novel shut-off nozzle for use with an injection molding system that is effective in processing and foaming polymers and forming final products and components. The novel arrangement of a shut-off mechanism and cooling system of the shut-off nozzle increases cell nucleation during the foaming process, increases the pressure drop as the polymer is injected into a mold to promote cell growth and stabilization, limits drooling at the end of each injection cycle, and solidifies polymer left in a nozzle tip between cycles to facilitate ejection of the solidified polymer prior to the subsequent cycle.

Polymer foams, and more particularly, thermoplastic foams, are formed by saturating polymers with gases while in a molten state. One mechanism for such saturation is to blend the polymer with a blowing agent wherein gases are created from chemical reactions of a chemical blowing agent. Another mechanism is to inject gas directly into the flow of molten polymer followed by a rapid thermodynamic instability. Such processes result in the creation of a large number of instantaneous nuclei. A portion of such nuclei progress to cell growth due to pressure drop, surface tension of saturated molten polymer, and/or normal or shear stress applied to the molten polymer. Such cell growth results in voids in the final molded product, which advantageously reduces the density and thus the weight of the final molded product. The above-mentioned parameters affect the value of critical radius (r*) for the desired cells. If the injection molding process results in an increase of cells with a radius that is greater than the critical radius, more cells will progress to an enhanced growth stage and result in successful foaming and weight reduction in the final molded product. Conversely, if more cells have radius less than the critical radius, the cells will dissipate, reducing the probability of successful foaming and weight reduction of the final molded product. An important parameter of a foaming process to manage through shut-off nozzle design is the level of additional stresses (normal and shear) applied to the flow of molten polymer as it progresses through the injection molding machine. Therefore, the design of the flow path within the shut-off nozzle can result in a more successful foaming process.

The novel shut-off nozzles disclosed herein produce higher foaming and expansion of the molten polymer, more consistent injection of the molten foamed polymer into the mold cavity, and superior surface finishes for molded components. Additionally, the novel shut-off nozzles avoid the common issue of a semi-solid plastic sprue part (i.e., a “cold slug”) left in the nozzle tip between cycles such that the cold slug from one molding cycle is injected into the mold cavity during the subsequent molding cycle, which negatively affects the subsequent molded part.

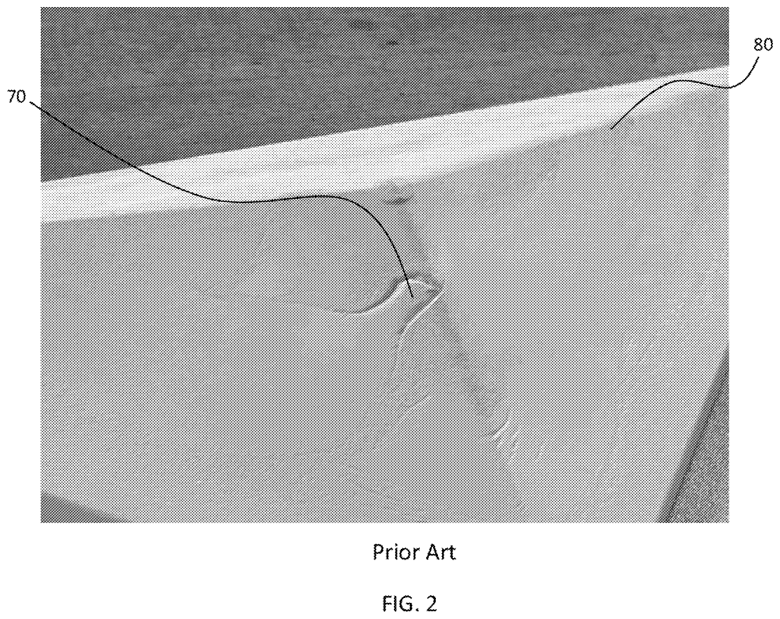

The shut-off nozzle and processes disclosed herein are well-suited for parts and components that benefit from precise dimensions, consistent physical and mechanical properties, and unmarred surfaces. Certain industries, such as medical devices, particularly for devices that are used in or implanted into the human body; automotive; aerospace, and other similar industries prefer or require high dimensional precision and unblemished surfaces. In addition, such industries highly value consistency and structural integrity in components. As discussed herein, injection molding machines using prior art shut-off nozzles often result in inconsistent foaming properties for polymers processed through the injection molding machine and inferior molded parts that often include significant surface imperfections and structural integrity issues. One example of a surface imperfection common in foamed polymer components molded using a prior art shut-off nozzle (such as the shut-off nozzle 100 illustrated in FIG. 1) is depicted in the photograph of FIG. 2. As will be appreciated, when the distance between the location where the pin 30 shuts off the flow of molten polymer and the nozzle tip 60 (represented as D₁ in FIG. 1) is significant and that molten polymer in the nozzle tip is not adequately cooled and solidified, the ejection of the leftover material is not effective or efficient. This results in a portion of the cold slug remaining in the nozzle tip between injection cycles. The cold slug often remains in a form of an elongated stringy remnant. During the next injection cycle, the cold slug is injected into the cavity of the mold in its semi-solid state. The cold slug typically moves to the far end of the cavity, and as illustrated in FIG. 2, this cold slug often causes a significant irregularity or imperfection 70 in the surface of the molded article 80. In other examples, the cold slug can be located within the body of the molded article where it can affect the structural integrity of the molded article. It will be readily understood that such outcomes result in inferior foam molded parts and components that may be unsuitable for industries that desire or require precision parts and components.

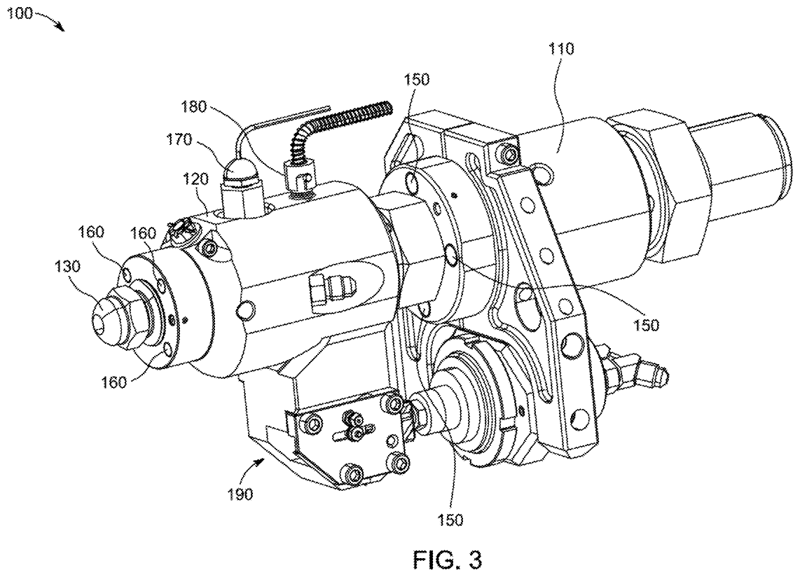

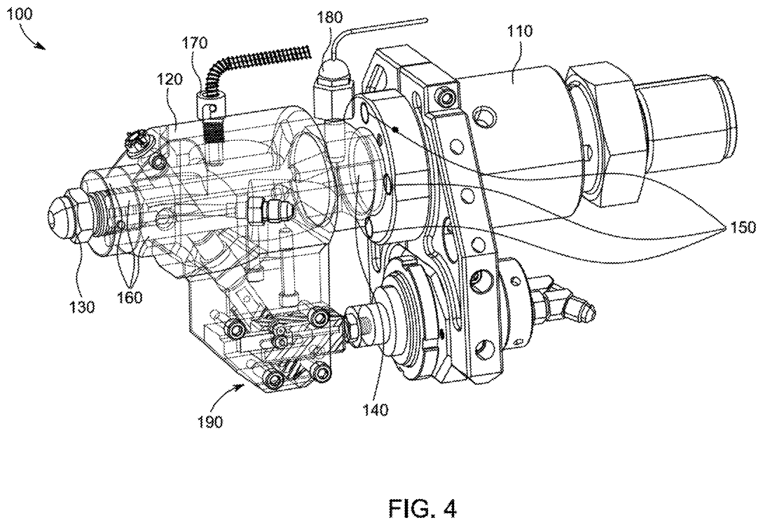

With reference to FIGS. 3-19, an exemplary embodiment of a shut-off nozzle 100 for use with an injection molding machine (not shown) is illustrated. It will be appreciated that such a shut-off nozzle 100 is arranged to attach to the end of an injection molding machine and designed to channel molten polymers from the injection molding machine to the cavity of a mold. In one embodiment, the shut-off nozzle 100 is arranged to attach to the injection molding machine via threaded screw arrangement. The shut-off nozzle 100 includes a main body 110, a connector body (also referred to as a spacer) 115 connected to one end of the main body 110, a nozzle tip body 120 connected to the opposite end of the main body 110, and a nozzle tip 130 partially positioned within the nozzle tip body 120. The connector body 115 connects the shut-off nozzle 100 to an injection molding machine. A flow path 140 passes through the main body 110, the nozzle tip body 120, and the nozzle tip 130 to provide a path for molten polymer, typically a thermoplastic polymer, to flow from the injection molding machine to the mold. The polymer is fed through the flow path 140 by a force provided by a reciprocating screw of the injection molding system. The shut-off nozzle 100 includes a number of heating elements, often referred to as heater cartridges, located near the flow path 140. For example, as illustrated in FIG. 4, four heating elements 150 are equally spaced around the flow path 140 in the main body 110 and apply heat to the main body 110 to maintain a constant temperature for polymer following through that section of flow path 140. Additionally, four heating elements 160 are equally spaced around the flow path 140 throughout the nozzle tip body 120 and apply heat to the nozzle tip body 120 and nozzle tip 130 to maintain a constant temperature for polymer following through that section of flow path 140. The heating elements 150, 160 are arranged to maintain the molten state of the polymer at constant temperature all along the flow path of 140 as the polymer passes through the shut-off nozzle 100.

The shut-off nozzle 100 includes a pair of temperature sensors 170, 180 positioned in the nozzle tip body 120. The first temperature sensor 170 is located at approximately the mid-point of the nozzle tip body 120 and extends downward into the flow path 140 so that the temperature sensor 170 directly measures the temperature of the polymer flowing through the flow path 140. The second temperature sensor 180 is located near the intersection of the main body 110 and the nozzle tip body 120 and provides an approximate measurement of the temperature of the polymer as it exits the main body 110 and enters the nozzle tip body 120. A control unit can receive and analyze the temperature measurements of the pair of temperature sensors 170, 180 and make any required adjustments to the heating elements 150, 160 positioned in the main body 110 and/or the nozzle tip body 120.

When the molten polymer reaches the end of the shut-off nozzle 100, it is periodically injected into a cavity of a mold through the nozzle tip 130. When the polymer processed through the shut-off nozzle 100 has a low viscous or high melt flow index, such as a polymer foam, the injection molding process benefits from a shut-off mechanism incorporated into the flow path. Such a shut-off mechanism, in its retracted state, allows the molten polymer to flow through the nozzle tip 130 and into the mold during each injection cycle but, in its actuated state, blocks the flow of the molten polymer in-between injection cycles.

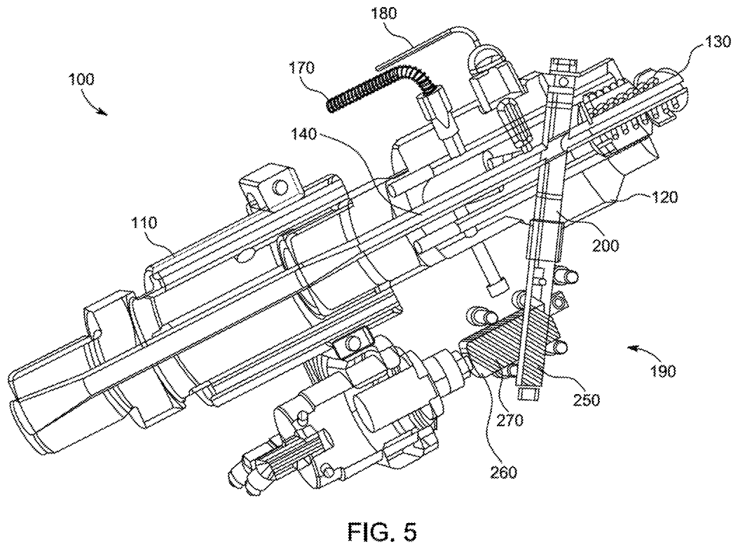

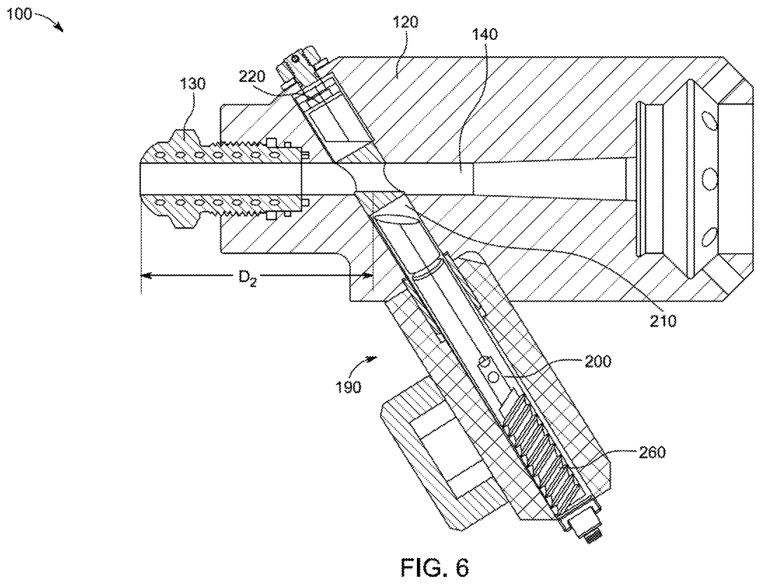

FIGS. 5 and 6 schematically illustrate cross-sectional views of a novel shut-off mechanism 190 for use in a shut-off nozzle 100. The shut-off mechanism 190 includes a pin 200 located in a passageway 210, where the pin 200 and passageway 210 are positioned at an angle to the flow path 140 such that when the pin 210 is actuated, it intersects the molten polymer flow in the flow path 140 at a location much closer to the end of the nozzle tip 130 than in prior art shut-off nozzles (represented by D₂ in FIG. 6). As illustrated, the passageway 210 extends past the flow path 140. A stationary stop 220 is located in the portion of the passageway 210 that extends past the flow path 140. The stationary stop 220 includes a surface located proximate to the flow path 140 that is arranged to engage with the leading surface of the pin 210 when the pin 210 is actuated. The engaging surfaces of the pin 210 and stationary stop 220 are arranged to facilitate a clean cut of the molten polymer flow through the flow path 140 and prevents any polymer from flowing upward into the passageway 210. The overall arrangement of the shut-off mechanism 190 significantly reduces the volume of molten polymer positioned between the shut-off location and the end of the nozzle tip 130 at the completion of each injection cycle. The flow path 140 prior to and after the location where the passageway 210 intersects the flow path 140 has a constant diameter. This constant diameter prevents early and inefficient cell nucleation as the polymer flows through the flow path 140 and onto the mold cavity.

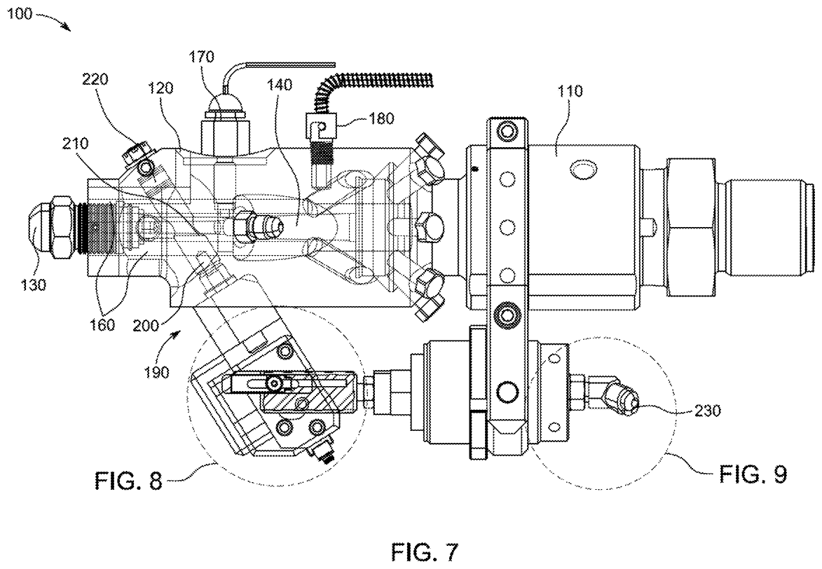

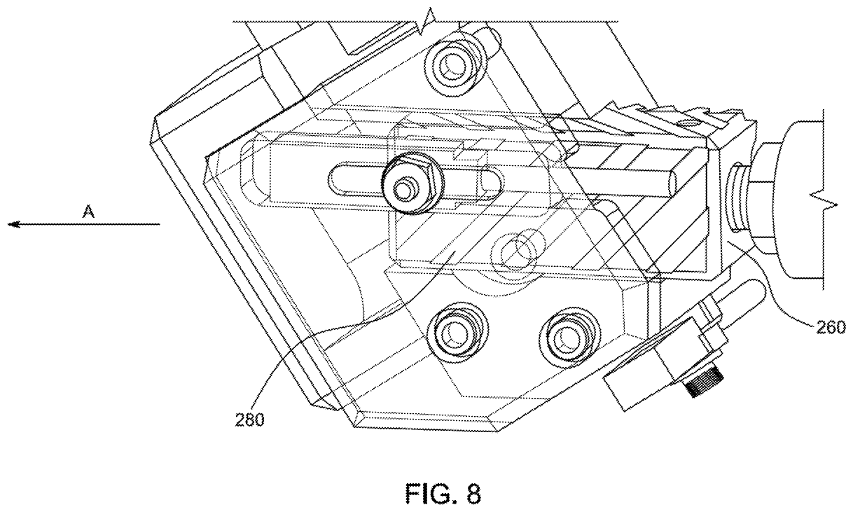

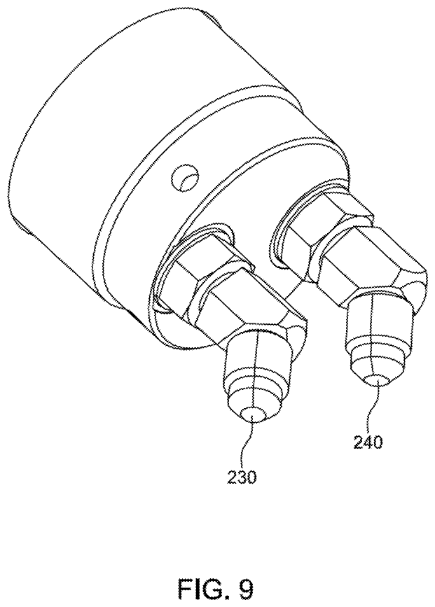

FIG. 7 schematically illustrates the shut-off nozzle 100 with a transparent nozzle tip body 120 showing the internal shut-off mechanism 190, and FIG. 8 schematically illustrates an enhanced view of the shut-off mechanism 190. The shut-off mechanism 190 can be actuated and retracted by a control unit using, for example, pneumatic or hydraulic power attached to an inlet 230 and an outlet 240 (illustrated in FIG. 9). The control unit can actuate the pin 200 to effectuate shut off of the molten polymer flow at the end of each injection cycle and engage the stationary stop 220 and can subsequently retract the pin 200 at the beginning of each injection cycle to allow molten polymer to flow through the flow path 140, out of the nozzle tip 130, and into the mold. It will be understood that the pin 200 can be actuated and driven through the passageway 210 to intersect with the flow path 140 by the allocation of pneumatic or hydraulic power.

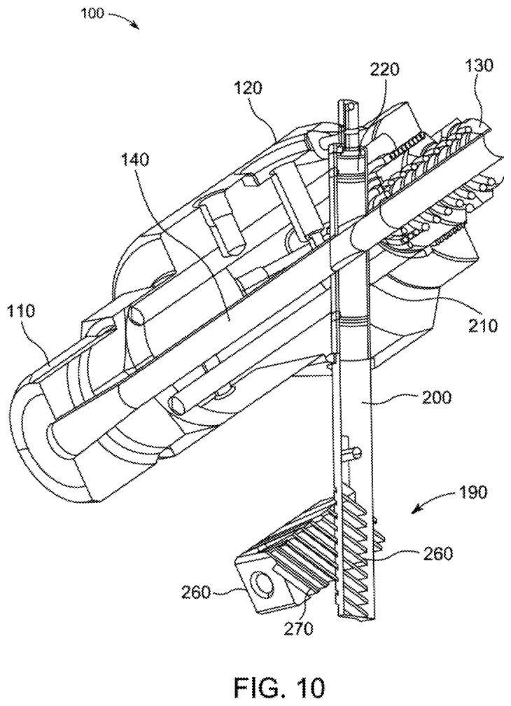

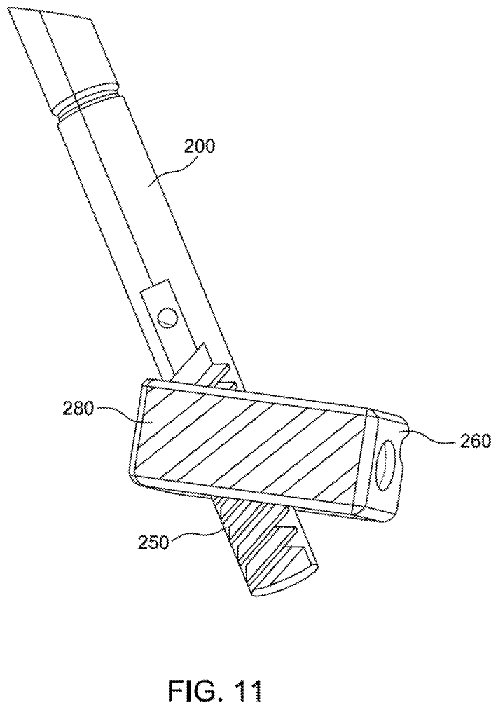

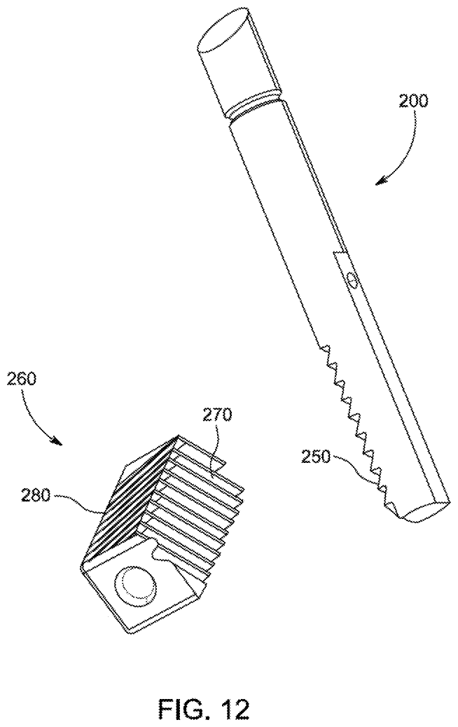

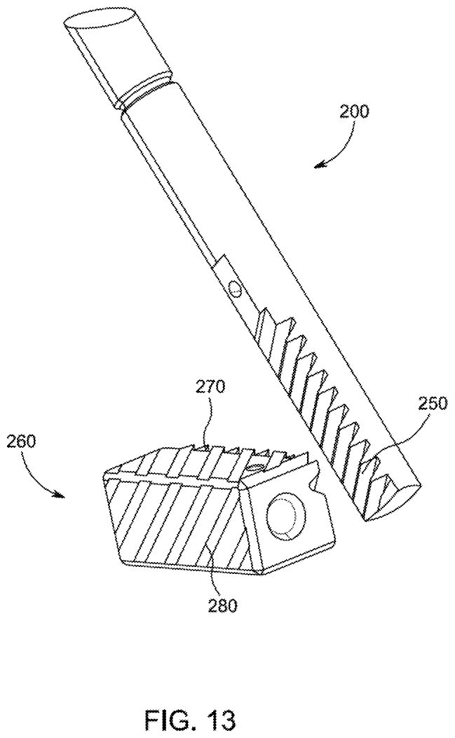

One mechanical mechanism for actuating and retracting the pin 200 through the passageway 210 includes a series of linear gear teeth 250 located at a lower portion of the pin 200 and a drive plate 260 that includes a series of linear gear teeth 270 that engage the linear gear teeth 250 of the pin 200. FIGS. 10 and 11 illustrates the linear gear teeth 250 of the pin 200 engaged with the linear gear teeth 270 of the drive plate 260. FIGS. 12 and 13 illustrate exploded views of the pin 200 and drive plate 260. The drive plate 260 includes a number of grooves 280 on its outside surfaces to accommodate a lubricant such as oil or grease to facilitate smooth movement of the drive plate 260 during actuation and retraction.

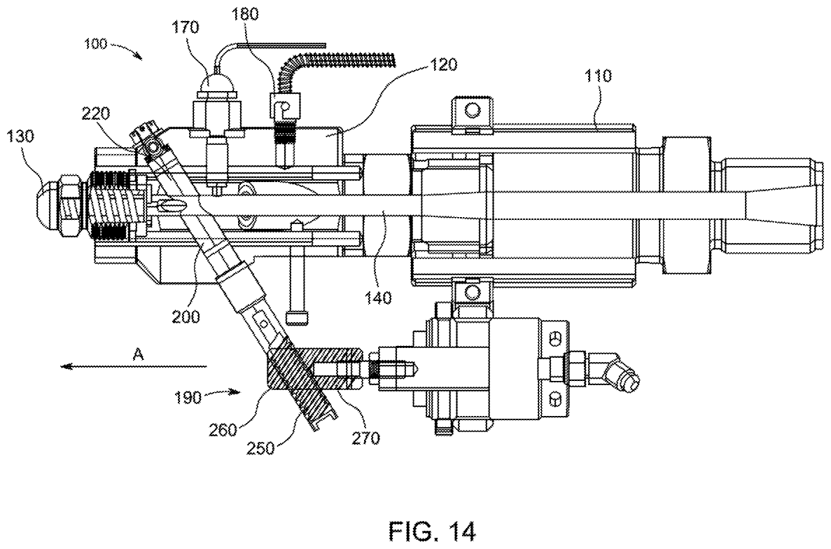

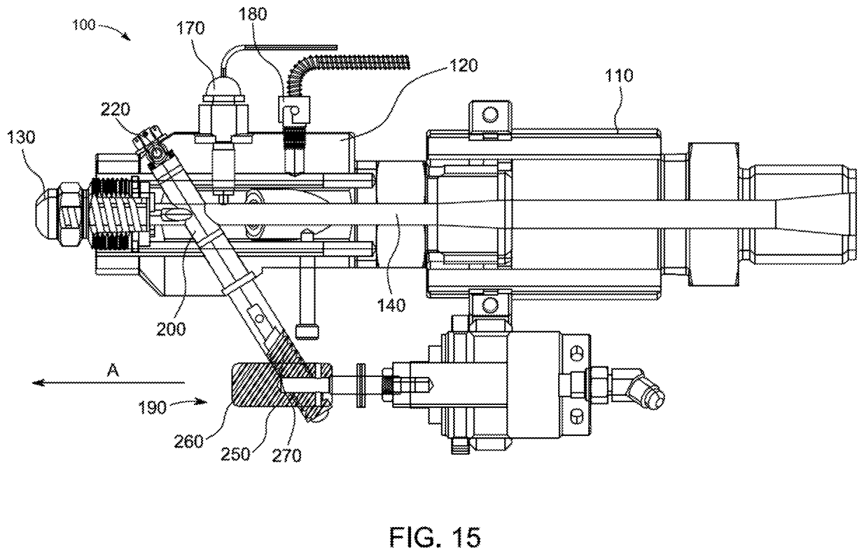

The position of the drive plate 260 and pin 200 in the retracted position is illustrated in FIG. 14, and the position of the drive plate 260 and pin 200 in the actuated position is illustrated in FIG. 15. When a pneumatic or hydraulic force is applied to the drive plate 260, the drive plate 260 is moved to the left (relative to FIGS. 8, 14, and 15 and in the direction of arrow A). As will be appreciated, the linear gear teeth 270 of the drive plate 260 are at an angle to the direction of movement of the drive plate 260. Thus, when the drive plate 260 moves in the direction of the arrow A, the engagement of the drive plate 260 linear gear teeth 270 and the pin 200 linear gear teeth 250 drives the pin 200 upward toward and through the flow path 140. When the pneumatic or hydraulic force is removed. The drive plate 260 is retracted to the right (relative to FIGS. 8, 14, and 15 and in the opposite direction of arrow A). When the drive plate 260 moves in the opposite direction of the arrow A, the engagement of the drive plate 260 linear gear teeth 270 and the pin 200 linear gear teeth 250 retract the pin 200, which moves downward away from the flow path 140 and returns the pin 200 to its unactuated position (as illustrated in FIGS. 6 and 14). The movement of the drive plate 260 is facilitated by application of hydraulic or pneumatic forces via the inlet 230 and outlet 240. To actuate the pin 200 by moving the drive plate 260 in the direction of arrow A, a hydraulic or pneumatic fluid is injected through the inlet 230 applying a positive force on the drive plate 260. To retract the pin 200 by moving the drive plate 260 in the opposite direction of arrow A, the hydraulic or pneumatic fluid is evacuated through the outlet port 240 which applies a back pressure or negative force to the drive plate 260.

In another embodiment, the actuation of the pin 200 can be directly driven by the application of a pneumatic or hydraulic force and the pin 200 is retracted by a biasing member, such as a spring (not illustrated). This is to say that when the pneumatic or hydraulic power is removed, the spring will retract the pin 200 and return it to its retracted position (as illustrated in FIG. 6). The spring can be arranged such that it elongates when the pin 200 is actuated and moved upward to intersect the flow path 140. Thus, when the pneumatic or hydraulic power is removed, the spring returns to its natural position and retracts the pin 200.

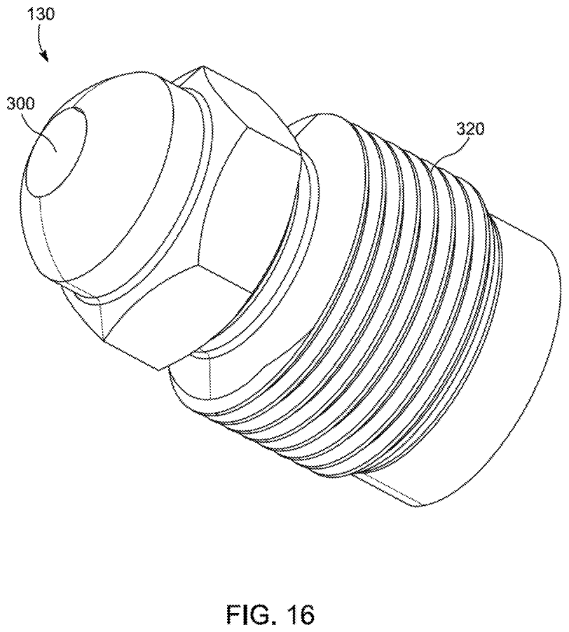

In addition to the novel angled shut-off mechanism 190, the shut-off nozzle includes a novel nozzle tip 130 as illustrated in FIGS. 16 through 19. The nozzle tip 130 is positioned partially within the nozzle tip body 120 such that an internal passage 300 within the nozzle tip 130 aligns with the flow passage 140. The nozzle tip 130 includes a novel cooling mechanism in the form of a fluid path 310 formed within the nozzle tip 130. This cooling mechanism rapidly cools and solidifies the molten polymer located between the actuated pin 200 of the shut-off mechanism 190 and the end of the nozzle tip 130 that remains in the flow path 140 and internal passage 300 of the nozzle tip 130 at the end of each injection cycle. Such a rapid cooling and solidification process forms a solid slug of polymer that can be effectively ejected together with the part(s) between injection cycles. The cooling process is arranged such that the process is rapid enough to significantly reduce or eliminate drooling and improves the injection molding process.

As noted above, four heating elements 160, such as cartridge heaters, are positioned within the nozzle tip body 120 to precisely maintain the temperature of the polymer flowing through the flow path 140 and internal passage 300 of the nozzle tip 130 during each injection cycle. At the end of each injection cycle, the pin 200 of the shut-off mechanism 190 is actuated to cut off the flow of polymer through the flow path 140. The heating elements 160 are turned off and a cooling system is initiated to rapidly solidify the remaining polymer in the flow passage 140 and in the internal passage 300 of the nozzle tip 130.

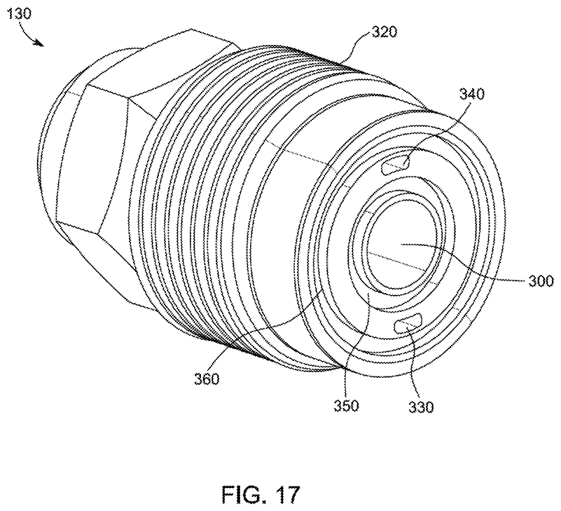

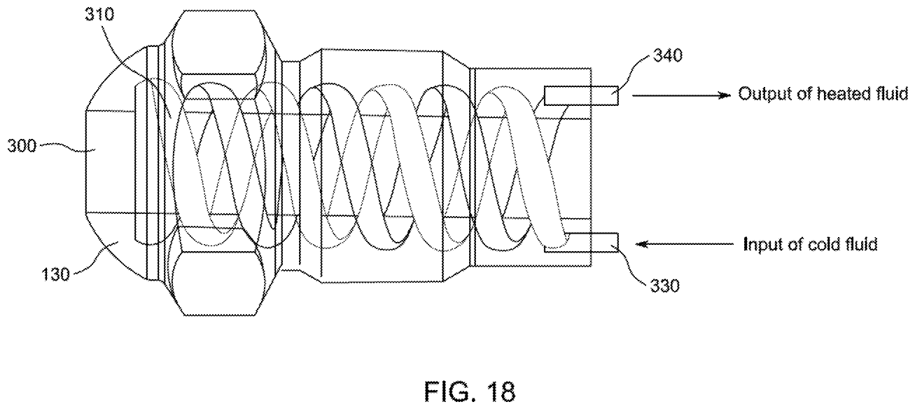

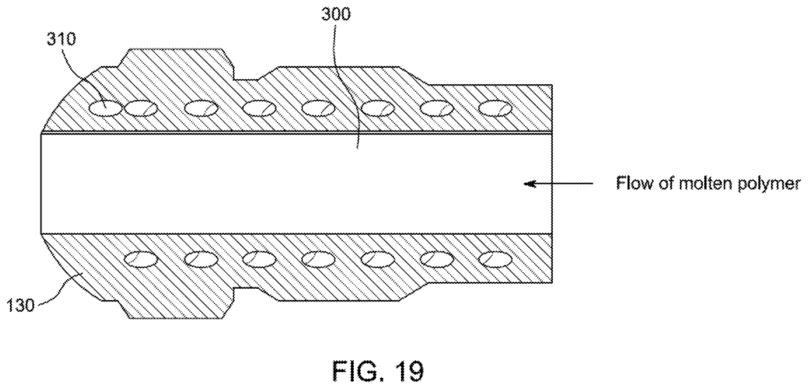

FIGS. 16 and 17 illustrate perspective views of the nozzle tip 130. The nozzle tip 130 includes a threaded section 320 on its outer diameter. The threaded section 320 is useful in securing the nozzle tip 130 to the nozzle tip body 120. The nozzle tip 130 further includes a first port 330 and a second port 340 (as illustrated in FIG. 17). The first port 330 can be attached to a fluid source to channel fluid into and through the fluid path 310, and the second port 340 can be attached to a fluid line to evacuate fluid from the fluid path 310. With reference to FIGS. 18 and 19, the fluid path 310 of the nozzle tip 130 includes an efficient helix water cooling circuit surrounding the internal passage 300 of the nozzle tip 130. The fluid path 310 includes a continuous double helix. The initial portion of the helix accepts the input of cold water or other fluid via the first port 330 and moves the cold water from the rear of the nozzle tip 130 to the front end of the nozzle tip 130. Once the helix reaches the front end of the nozzle tip 130, the helix reverses course and moves the fluid back toward the rear of the nozzle tip 130 where it exits the nozzle tip 130 through the second port 340. In the embodiment of FIGS. 16-19, the cross-sectional shape of the fluid path 310 is generally oval.

As cold or cool water or other fluid is introduced into the helix and progresses through the nozzle tip 130, the fluid removes heat from the polymer remaining in the internal passage 300 of the nozzle tip 130. The continuous double helix nature of the fluid path 310 makes two passes through the nozzle tip 130, which removes more heat from the polymer in the internal passage 300 of the nozzle tip 130. Thus, the process results in the rapid cooling and solidification of the residual molten materials, which will be ejected or otherwise removed prior to the subsequent injection cycle. The cooling effects of the fluid path 310 not only cools and solidifies the polymer in the internal passage 300, but the cooling effect also cools and solidifies the polymer that is in the flow path 140 between the actuated pin 200 and the nozzle tip.

To prepare for the next injection cycle, the four heating elements 160 in the nozzle tip 130 are initiated to heat the nozzle tip 130 to prepare for additional polymer to flow through the nozzle tip 130. The internal passage 300 is a large channel that is designed to prevent early and inefficient cell nucleation as the polymer is injected into the cavity of the mold during the injection cycle. The flow path 140 through a significant portion of the shut-off nozzle and the internal passage 300 through the nozzle tip 140 maintain a constant diameter and cross-sectional area along their lengths, which further prevents early and inefficient cell nucleation as the molten polymer prepares to be injected into the mold cavity.

As illustrated in FIG. 17, the rear surface of the nozzle tip 130 includes two concentric grooves 350, 360. A first groove 350 is positioned between the first 330 and second 340 ports and the internal passage 300. The second groove 360 is positioned between the first 330 and second 340 internal ports and the outside surface of the nozzle tip 130. An O-ring or similar gasket can be placed into each groove 350, 360 to prevent leakage of the cooling fluid into the internal passage 300 or outside the nozzle tip 130.

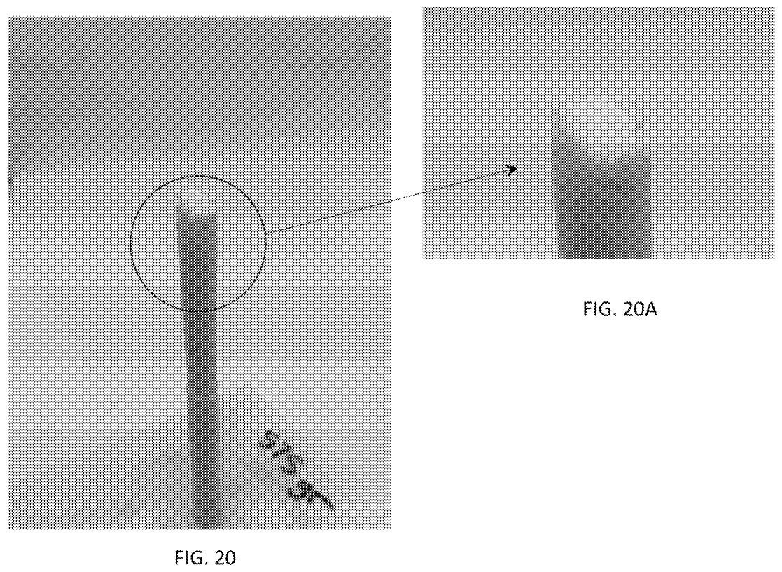

FIG. 20 is a photographs of an article made using the novel shut-off nozzle with the full sprue remaining intact, and FIG. 20A is an enhanced view of the portion of the sprue that interacted with the pin 200. The sprue represents the solidified polymer that remains in the internal passage 300 of the nozzle tip 130 and the flow path 140 between the actuated pin 200 and the nozzle tip 130 at the end of each injection cycle and cooling period. As is shown in the photographs, there is a clean cut in the polymer material and not a stringy remnant of material that is present when using prior art shut-off nozzles. Thus, the novel shut-off nozzle 100 remediates the irregularities that result from the use of prior art shut-off nozzles.

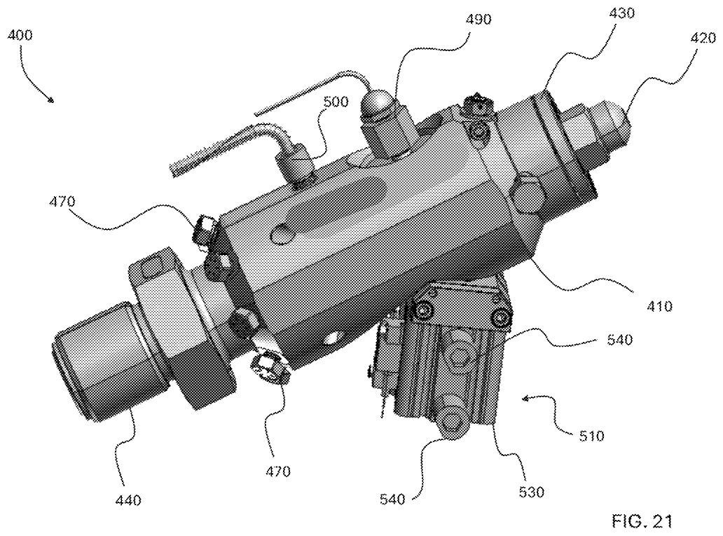

With reference to FIGS. 21-29, another exemplary embodiment of a shut-off nozzle 400 for use with an injection molding machine (not shown) is illustrated. The shut-off nozzle 400 is arranged to attach to the end of an injection molding machine and designed to channel molten polymers from the injection molding machine to the cavity of a mold. In comparison to prior embodiments described herein, the shut-off nozzle 400 of FIGS. 21-29 includes: a threadless arrangement to rotationally orient the shut-off nozzle 400 relative to an injection molding machine and mold; a single set of heating elements and a single heating zone; a more compact overall design; a direct drive mechanism for actuating and retracting the shut-off pin; a cooling mounting block around the shut-off pin direct drive mechanism; a sensor to determine the position of the shut-off pin; a fastening mechanism to secure the nozzle tip to the main body; and a mechanism for introducing and evacuating cooling fluid directly into and out of the nozzle tip.

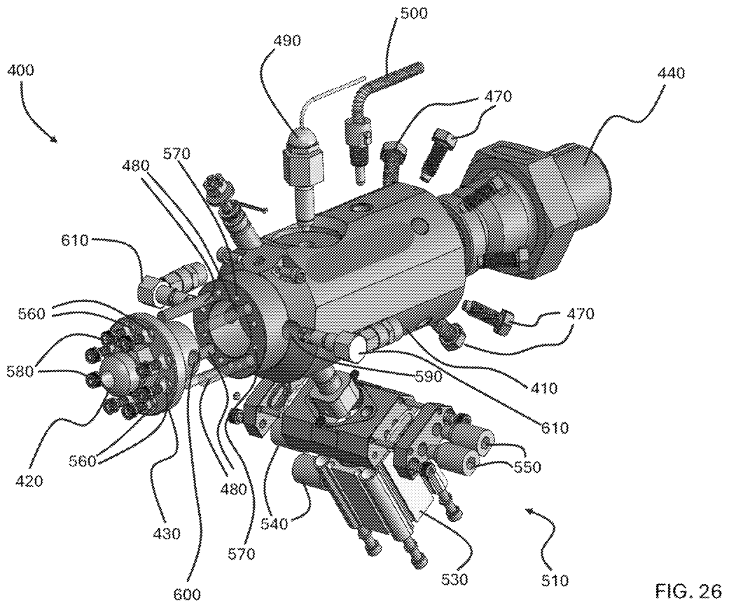

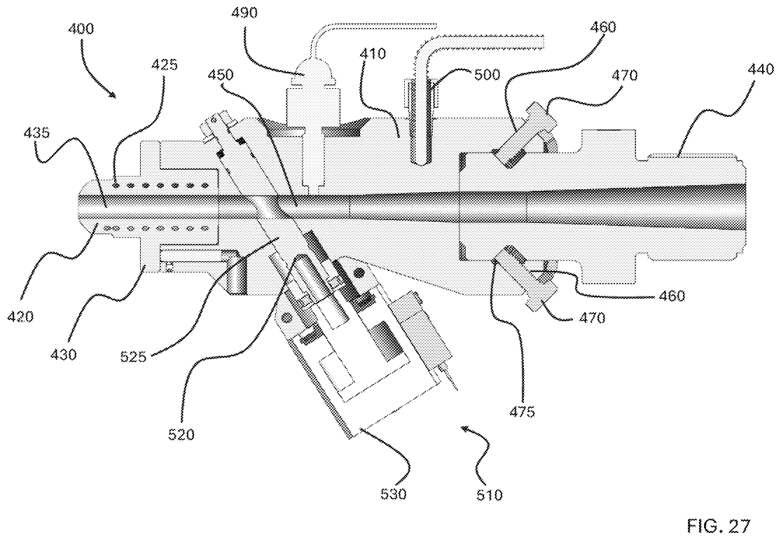

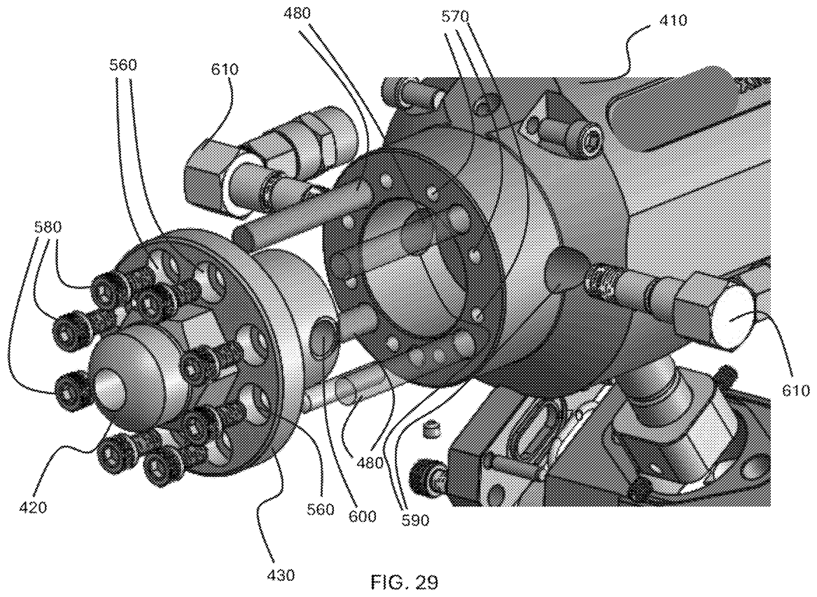

FIGS. 21-25 illustrate various views of the shut-off nozzle, FIG. 26 is an exploded view of the shut-off nozzle 400, FIGS. 27, 28, and 30 are cross-sectional views of the shut-off nozzle 400, and FIG. 29 is an enhanced view of the forward section of the shut-off nozzle 400. The shut-off nozzle 400 includes a main body 410, a nozzle tip 420 that includes a flange 430, and a connector body (sometimes referred to as a spacer) 440. The connector body 440 is attached to one end of the main body 410 and connects the shut-off nozzle 400 to an injection molding machine. The nozzle tip 420 is attached directly to the main body 410 at the opposite end of the main body 410 to where the connector 440 is attached. As will be appreciated, this arrangement of a shut-off nozzle 400 uses on component (referred to as a main body 410) in place of two components (referred to as the main body 110 and the nozzle tip 120) described and illustrated for other foregoing embodiments.

A flow path 450 passes through the main body 410 and is colinear with an internal passage 435 through the nozzle tip 420 to provide a path for molten polymer, typically a thermoplastic polymer, to flow from the injection molding machine to the cavity in the mold. The polymer is fed through the flow path 450 by a force provided by a reciprocating screw of the injection molding system. Prior to the portion of the flow path 450 that is a constant diameter, there are transition points that gradually reduce the diameter of the flow path leading from the injection molding machine. In this embodiment of the shut-off nozzle 400, those transition points gradually reduce the diameter of the flow path to reduce any potential pressure drops and generate better foaming of the polymer.

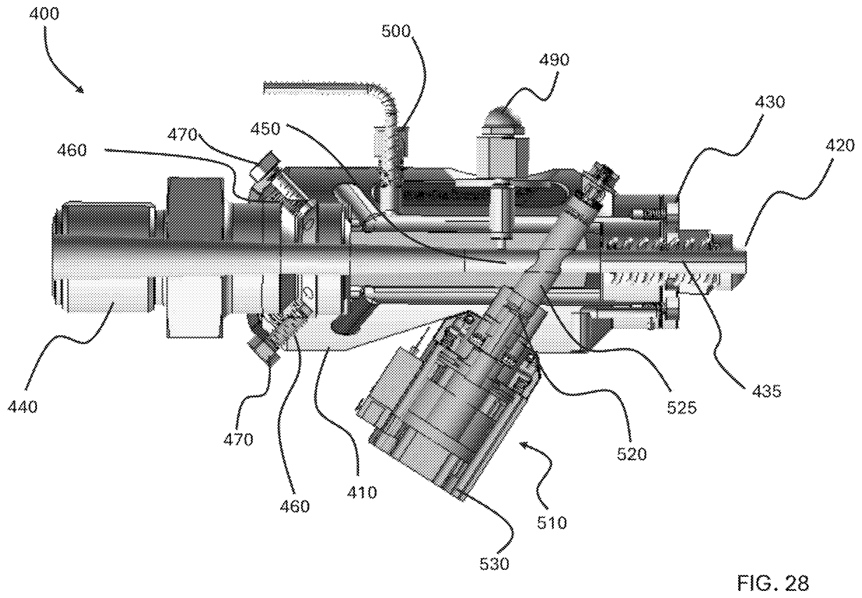

The shut-off nozzle 400 is arranged to be attached to an injection molding machine. During such an attachment process, the shut-off nozzle 400 can be efficiently rotationally positioned in a desirable rotational orientation. As will be further described (and best illustrated in FIGS. 27 and 28), one end of the main body 410 includes a series of threaded apertures 460 arranged to accommodate fasteners such as bolts 470. In this particular embodiment, the main body 410 includes eight such apertures 460. When the shut-off nozzle 400 is attached to the barrel of an injection molding machine, the connector body 440 is first secured to the barrel of the injection molding machine through a threaded connection on one end of the connector body 440. Once the threaded connection of the connector body 440 is secured to the barrel pursuant to the specifications of the injection molding machine, the main body 410 is positioned over the opposite end of the connector body 440 (as illustrated in FIGS. 27 and 28). The main body 410 is then rotated (or “clocked”) until the desired rotational position relative to the injection molding machine and mold is achieved. The fasteners 470 are threaded through the apertures 460 of the main body 410 until the fasteners 470 engage the outer surface of the connector body 440 and tightened to secure the main body 410 to the connector body 440. Optionally, the connector body 440 can include a groove 475 on its outer surface with a flat surface relative to the terminal end of the fastener 470 (as illustrated in FIG. 27) or other such feature to provide for secure engagement of the fasteners 470 and connector body 440. It will be appreciated that with the arrangement of the fasteners 470 and groove 475 and the engagement of the terminal end of the fasteners 470 and flat surface of the groove 475, the connector body 440 and main body 410 are securely coupled together to withstand the pressures of the injection molding process. As will be further appreciated, the process described above provides for precise rotational positioning of the shut-off nozzle 400 relative to both the injection molding machine and the mold.

The shut-off nozzle 400 includes one set of heating elements, often referred to as heater cartridges, located around the flow path 450. As illustrated in FIG. 26, four elongated heating elements 480 are equally spaced around the flow path 140 in the main body 410 proximate to where the nozzle tip 420 engages with the main body 410 and apply heat to the main body 410 to maintain a constant temperature for polymer following through the flow path 450. The heating elements 480 are arranged to maintain the molten state of the polymer at constant temperature all along the flow path 450 as the polymer passes through the shut-off nozzle 400.

As illustrate in the figures, the shut-off nozzle 400 includes a pair of temperature sensors 490, 500 positioned in the main body 410. A first temperature sensor 490 is located at approximately the mid-point of the main body 410 and extends downward into the flow path 450 so that the temperature sensor 490 directly measures the temperature of the polymer flowing through the flow path 450. A second temperature sensor 500 is located near the intersection of the main body 410 and the connector body 440 and provides a measurement of the temperature of the main body 410. Alternatively, the first temperature sensor 490 can be arranged to measure the temperature of the main body 410 and the second temperature sensor 500 can be arranged to extend downward into the flow path 450 so that the second temperature sensor 500 directly measures the temperature of the polymer flowing through the flow path 450. Under either arrangement of the temperature sensors 490 and 500, a control unit can receive and analyze the temperature measurements from the pair of temperature sensors 490, 500 and make any required adjustments to the heating elements 480 positioned in the main body 410 to maintain the desired temperature throughout the shut-off nozzle 400 to facilitate optimal injection molding processes.

In addition to the two temperature sensors described above and illustrated in the figures, additional temperature sensors can be positioned along the length of the shut-off nozzle depending on desired design and sensitively of the polymer used in the injection molding process. In one embodiment, a temperature sensor can be placed in contact with the flange of the nozzle tip to monitor the temperature of the nozzle tip. It will be appreciated that the temperature of the nozzle tip fluctuates during each injection molding cycle, with a high temperature while molten polymer is injected into the cavity of a mold and low temperature when the molten polymer in the nozzle tip is cooled and solidified. Using a temperature sensor to monitor and track the change in temperature over time at the nozzle tip can be used to evaluate the performance of the shut-off nozzle. For example, if the temperature at the nozzle tip begins to demonstrate unexpected fluctuations, it may be an indication that the nozzle tip is not cooling to specifications. This can indicate that the cooling fluid is not flowing as expected or some other issue has developed that should be addressed.

The shut-off mechanism 510 is arranged to be actuated and retracted with a direct drive mechanism, where a cylinder or other component engaged with the shut-off pin 520 directly actuates and retracts the shut-off pin 520 to move the shut-off pin 520 in a passageway 525 that intersects the flow path 450. The direct drive mechanism can be mechanical, pneumatic, hydraulic, or other such method. The direct drive mechanism and shut-off pin 520 are positioned within a housing 530. Such an arrangement provides for a more compact overall shut-off nozzle 400 profile than for other embodiments described herein. The shut-off mechanism 510 can include a cooling block positioned around or proximate to the moving components of the shut-off mechanism 510 and manages any heat generated by the shut-off mechanism 510. Such heat management prevents warping or other deformation of moving components or any other mechanical components due to heat generated by friction or any other method and prevents heat generated by the shut-off mechanism 510 from radiating throughout the shut-off nozzle 400 and affecting the molten polymer flowing through the shut-off nozzle 400. The cooling block can also prevent heat generated by the heating elements 480 from radiating throughout the shut-off nozzle 400 and affecting the shut-off mechanism 510.

The shut-off mechanism 510 can include features that provide for water or other coolant to be circulated through the cooling block to manage the temperature of the shut-off mechanism 510. For example, the shut-off mechanism 510 can include inlet 540 and outlet 550 ports that facilitate the flow of water or other coolant through the cooling block. The cooling block can further include temperature sensors that provide continuous or periodic information to the control unit which can use such information to control the flow of water or other coolant passing through the cooling block to properly regulate temperatures of the shut-off mechanism 510 and the shut-off nozzle 400. The control unit can further use such information to temporarily pause the injection molding process if temperatures are above a pre-set maximum.

The shut-off mechanism 510 can further include a position sensor that is arranged to determine the position of the pin 520. The position sensor can provide information to the control unit regarding pin 520 position to facilitate proper and error-free operation of the shut-off nozzle 400 for each injection molding cycle. This is the say that if the injection molding system requires the pin 520 to be in an actuated position, the position sensor can confirm that the pin 520 is in an actuated position, and if the injection molding system requires the pin 520 to be in a retracted position, the position sensor can confirm that the pin 520 is in a retracted position. The position sensor can be arranged in a variety of configurations. For example, two position sensors can be placed along the path of the shut-off pin 520 in the passageway 525, one positioned at a location that senses when the shut-off pin 520 is in the actuated position and one positioned at a location that senses when the shut off pin 520 is in the retracted position. In other examples, sensors can be attached to the cylinder that drives the shut-off pin 520 or the shut-off pin itself so as to determine the position of the shut-off pin 520.

As will be further described, in one embodiment, the nozzle tip 420 is secured to the main body 410 by the flange 430 and a series of fasteners. In one embodiment, the flange 430 is formed as an integral part of the nozzle tip 420. In other embodiments, the flange 430 and nozzle tip 420 may be separate components and secured together through welding or any other securing method. As best illustrated in FIG. 29, the flange 430 includes a series of apertures 560 and the main body 410 includes a series of matching threaded apertures 570. In the embodiment illustrated, the flange 430 and main body 410 include eight equally spaced apertures 560, 570. When the nozzle tip 420 is positioned in engagement with the main body 410, a series of fasteners, such as bolts, 580 are passed through the apertures 560 of the flange 430 and into the threaded apertures 570 of the main body 410, thus, securing the nozzle tip 420 to the main body 410. Once the nozzle tip 420 is secured to the main body 410 and the connector body 440 is secreted to the main body 410, the shut-off nozzle 400 can is attached to the injection molding machine and injection molding processes can begin.

As noted above for other embodiments, in between cycles during injection molding processes, polymer located in the nozzle tip 420 is cooled and solidifies so that it can be ejected along with the molded part. In this arrangement, water or other coolant can be directly provided to the cooling mechanism (in the form of a fluid path 425) of the nozzle tip 420 (as opposed to flowing through other bodies of the shut-off nozzle 400). As illustrated in FIG. 29, the main body 410 includes a pair of ports 590 located opposite each other. The nozzle tip 420 also includes a matching pair of ports 600 (only one illustrated in FIG. 29) that align with the ports 590 of the upon assembly of the nozzle tip 420 with the main body 410. The pair of ports 600 in the nozzle tip 420 directly feed the fluid path 425 (a helix cooling circuit) surrounding the internal passage 435 of the nozzle tip 420. A pair of adaptors 610 are used to introduce and evacuate water or other coolant from the nozzle tip 420 to cool and solidify the polymer in the nozzle tip 420. In one embodiment, the adapters 610 are secured to the ports of the main body 410. In addition to the use of water or other liquid coolants, gases such as air or nitrogen can be used as the cooling fluid moving through the fluid path 425 of the nozzle tip 400. In certain embodiments, whether the fluid is a liquid or a gas, the fluid can be cooled prior to entering the nozzle tip 420 to better facilitate cooling of the polymer in the nozzle tip 420. In other embodiments, filters can be included in the shut-off nozzle or in apparatus delivering fluid to the shut-off nozzle to filter out any impurities or contaminants in the fluid stream. Such an arrangement is particularly useful when the cooling fluid is recycled.

The embodiment illustrated in FIGS. 21-29 generally illustrates a compact embodiment of a shut-off nozzle 400. However, the shut-off nozzle is configurable to meet many different environments and injection molding processes. Due to constraints determined by the physical structure of injection molding machines and molds, the length of a shut-off nozzle may require customization to properly operate with specific injection molding machines and molds. In one example, to adjust to the distance between an arrangement of an injection molding machine and a mold, any of the components of a shut-off nozzle can be lengthened or shortened. For example, if it is required for the distance between the injection molding machine and mold to be relatively large, the nozzle tip can be lengthened, the main body can be lengthened, and/or the connector body can be lengthened. In embodiments where the overall length of the shut-off nozzle is lengthened, additional temperature sensors (such as those illustrated using reference numbers 490 and 500) to monitor and control the temperature of the molten polymer as it progresses through the shut-off nozzle can be used. In such embodiments, temperature zones can be created, each three to four inches in length, that are monitored and/or controlled by temperature sensor(s). Conversely, if the distance between the injection molding machine and mold needs to be relatively small, the nozzle tip can be shortened, the main body can be shortened, and/or the connector body can be shortened. Thus, the shut-off nozzles disclosed herein are designed to be modular and configurable to meet a variety of injection molding machines, physical setups, and processes.

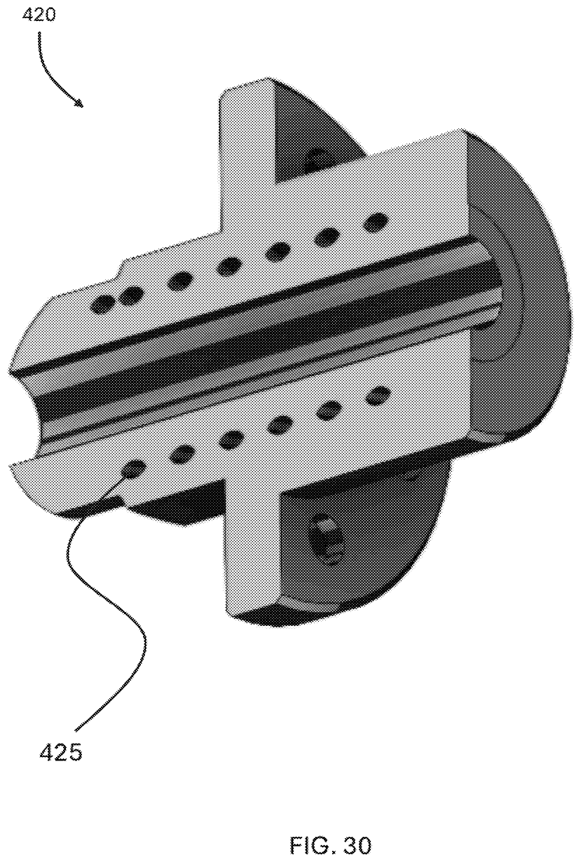

FIG. 30 illustrates a cross-sectional view of a nozzle tip 420 showing the fluid path 425. The shape of the fluid path 425 is generally prolate-spheroid shaped with a cross-section that is generally elliptical with tapered ends (often referred to as “football shaped”). The shape of the fluid path 425 can result in improved heat transfer from the molten polymer in the nozzle tip 420 to the fluid moving through the fluid path 425. For example, certain shapes of the fluid path promote turbulent flow, which enhances rapid heat transfer from the polymer in a nozzle tip to the fluid in the fluid path. The turbulent nature of the flow (i.e., chaotic and agitated motion mixing the fluid in the fluid path) efficiently and rapidly presents cooler fluid molecules proximate to the hot polymer, which rapidly transfers heat from the molten polymer to the fluid passing through the fluid path. The football shaped fluid path 425 of FIGS. 27 and 30 promotes turbulent flow, which promotes efficient heat transfer to rapidly cool and solidify molten polymer in the nozzle tip 420 between injection cycles. In addition to the football shaped fluid path, other shapes (generally non-circular shapes) also promote turbulent flow. The helix nature of the fluid paths described herein also promote turbulent flow.

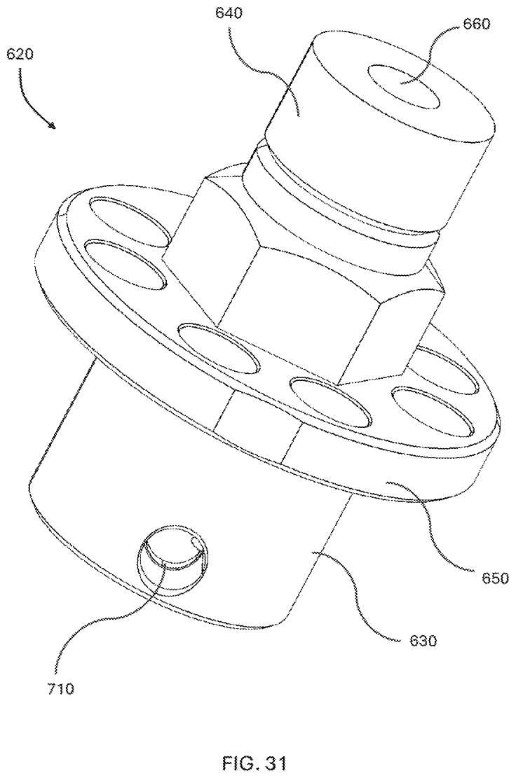

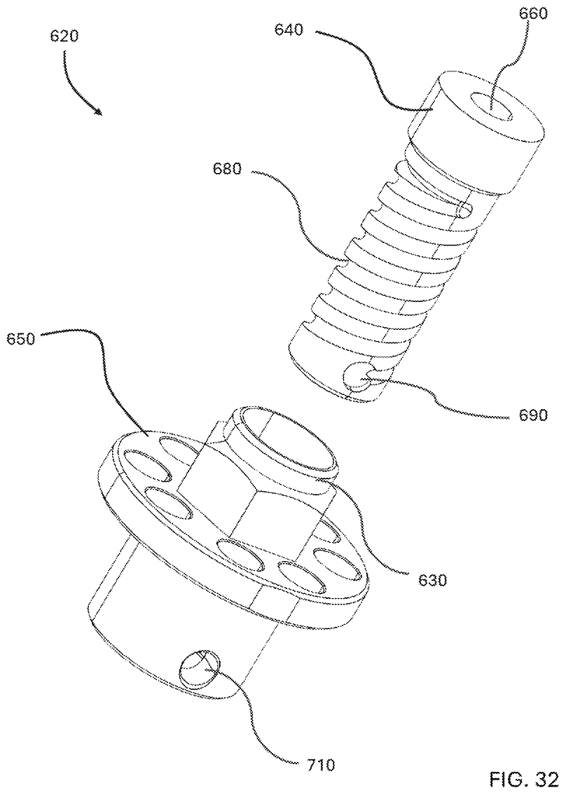

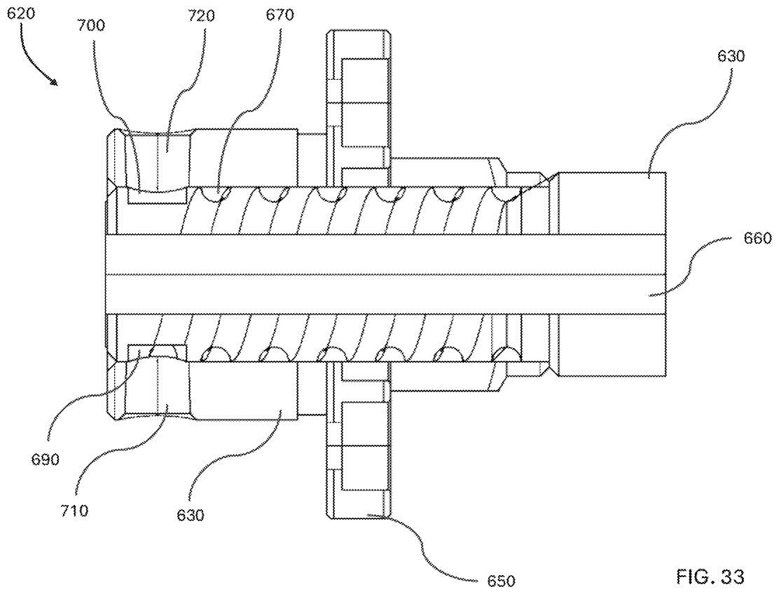

Nozzle tips can be fabricated as one unitary structure through manufacturing methods such as three dimensional printing and other additive manufacturing processes. The nozzle tip can also be fabricated as more than one part that are assembled into a nozzle tip assembly. FIGS. 31-33 illustrate views of a two-piece nozzle tip assembly 620. FIG. 31 is a perspective view of a two-piece nozzle tip assembly 620, FIG. 32 is an exploded view of the two-piece nozzle tip assembly 620, and FIG. 33 is a cross-sectional view of the two-piece nozzle tip assembly 620. The two-piece nozzle tip assembly 620 includes an outer component 630 and an inner component 640. The outer component 630 includes a flange 650 as previously described and the inner component 640 includes an internal passage 660 as previously described. A fluid path 670 (as best illustrated in FIG. 33) is formed by the engagement of the outer component 630 and inner component 640. The inner component 640 includes a double helix structure 680 formed on the outer surface of the inner component 640. When the inner component 640 is assembled with the outer component 630, the double helix structure 680 and the inner surface of the outer component 630 form a double helix fluid path 670 to facilitate the flow of a cooling fluid through the nozzle tip 620. The outer component 630 and the inner component 640 further combine to form inlet and outlet ports to further facilitate the flow of a cooling fluid through the nozzle tip 620. The inner component 640 includes an inlet aperture 690 and an outlet aperture 700 that engage with the respective ends of the double helix structure 680. The outer component 630 includes an inlet aperture 710 that aligns with the inlet aperture 690 of the inner component 640, and an outlet aperture 720 that aligns with the outlet aperture 700 of the inner component 640.

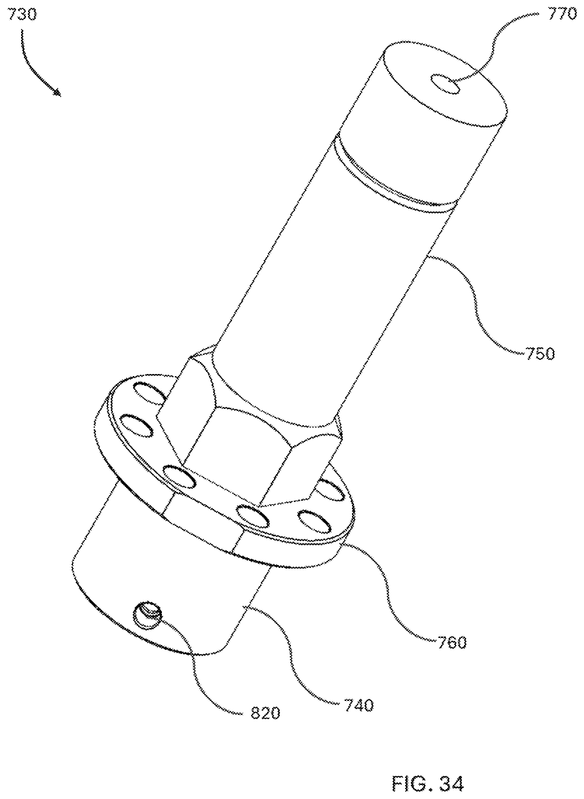

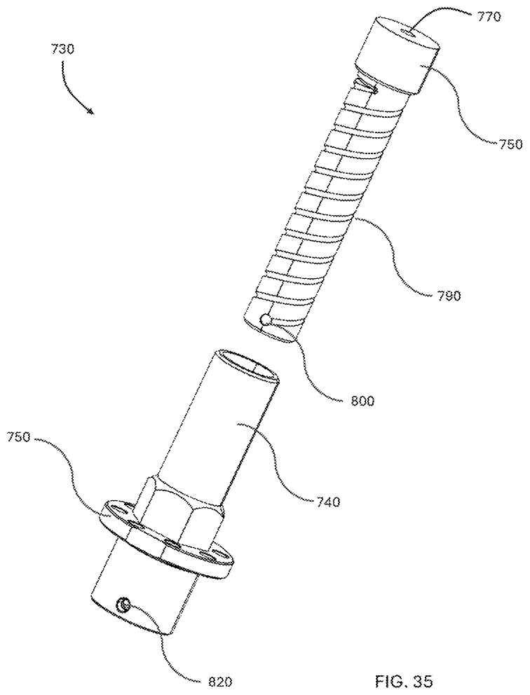

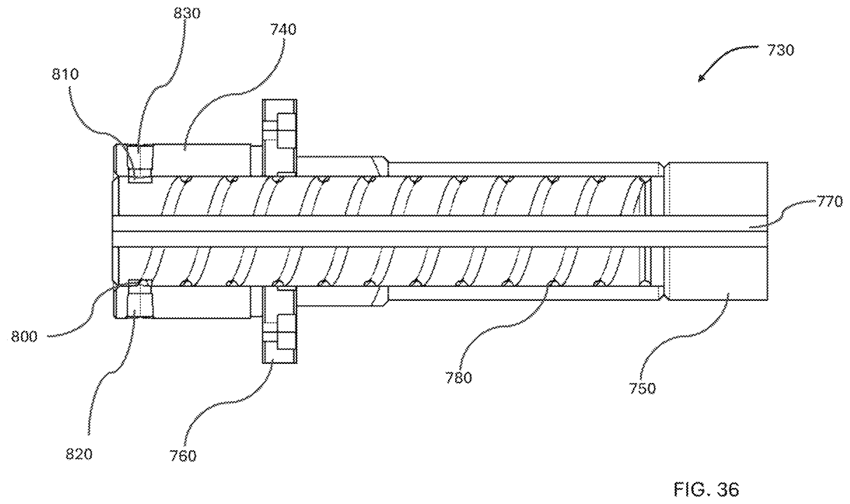

As previously described, shut-off nozzles are designed to be module, and one benefit of such modular design is the ability to lengthen or shorten the shut-off nozzle to meet physical and spatial requirements of specific injection molding machines and molds. FIGS. 34-36 illustrate another embodiment of a nozzle tip. This nozzle tip is an extended two-piece nozzle tip assembly 730. FIG. 34 illustrates a perspective view, FIG. 35 illustrates an exploded view, and FIG. 36 illustrates a cross-sectional view of the extended two-piece nozzle tip assembly 730. Similar to previously described two-piece nozzle tip assembly 620, the extended two-piece nozzle tip assembly 730 includes an outer component 740 and an inner component 750. As illustrated in the drawings, the extended two-piece nozzle tip assembly 730 is significantly longer than the two-piece nozzle tip assembly 620. The outer component 740 includes a flange 760 as previously described and the inner component 750 includes an internal passage 770 as previously described. A fluid path 780 (as best illustrated in FIG. 36) is formed by the engagement of the outer component 740 and inner component 750. The inner component 750 includes a double helix structure 790 formed on the outer surface of the inner component 750. When the inner component 750 is assembled with the outer component 740, the double helix structure 790 and the inner surface of the outer component 740 form a double helix fluid path 780 to facilitate the flow of a cooling fluid through the nozzle tip 730. The outer component 740 and the inner component 750 further combine to form inlet and outlet ports to further facilitate the flow of a cooling fluid through the nozzle tip 730. The inner component 750 includes an inlet aperture 800 and an outlet aperture 810 that engage with the respective ends of the double helix structure 790. The outer component 740 includes an inlet aperture 820 that aligns with the inlet aperture 800 of the inner component 750, and an outlet aperture 830 that aligns with the outlet aperture 810 of the inner component 750.

In an embodiment of the shut-off nozzle, a melt filter can be incorporated into the shut-off nozzle. A melt filter can be positioned in the flow path to remove contaminants and impurities from the molten polymer in the shut-off nozzle and before the molten polymer enters the cavity of the mold. A melt filter can be particularly useful when using recycled plastics as the source polymer for the injection molding process.

The foregoing description of examples has been presented for purposes of illustration and description. It is not intended to be exhaustive or limiting to the forms described. Numerous modifications are possible in light of the above teachings. Some of those modifications have been discussed, and others will be understood by those skilled in the art. The examples were chosen and described in order to best illustrate principles of various examples as are suited to particular uses contemplated. The scope is, of course, not limited to the examples set forth herein, but can be employed in any number of applications and equivalent devices by those of ordinary skill in the art.

We claim:

1. A shut-off nozzle for an injection molding process to form a polymer part, comprising:
a main body, wherein the main body includes a flow path through the main body;
a connector body securable to the main body;
nozzle tip securable to the main body, the nozzle tip comprising:
an internal passage; and
a cooling mechanism arranged to solidify molten polymer in the nozzle tip at an end of an injection cycle of an injection molding process such that the solidified polymer in the nozzle tip is joined with a formed polymer part; and
a shut-off mechanism comprising:
a passageway intersecting the flow path at an angle to the flow path; and
a pin positioned in the passageway;
wherein the flow path and internal passage are colinear when the nozzle tip is secured to the main body.

2. A shut-off nozzle for an injection molding process to form a polymer part comprising:
a main body, wherein the main body includes a flow path;
a connector body securable to a first end of the main body;
a nozzle tip securable to a second and opposite end of the main body, wherein the nozzle tip includes a flange; and
a shut-off mechanism, wherein the shut-off mechanism comprises:
a passageway that intersects the flow path at an angle to the flow path; and
a pin positioned in the passageway.

3. The shut-off nozzle of claim 2, wherein the flange is an integral part of the nozzle tip.

4. The shut-off nozzle of claim 2, wherein the flange is a separately fabricated component where a welding process is used to form the nozzle tip.

5. The shut-off nozzle of claim 2, wherein the pin is arranged to be movable between a first position and a second position.

6. The shut-off nozzle of claim 5, wherein when in the first position, the pin prevents polymer from flowing through the flow path.

7. The shut-off of claim 6, wherein when in the second position, the pin allows polymer to flow through the flow path.

8. A shut-off nozzle for an injection molding process to form a polymer part comprising:
a main body, wherein the main body includes a flow path through the main body; and
a nozzle tip securable to an end of the main body, the nozzle tip comprising:
an internal passage through the nozzle tip; and
a cooling mechanism that includes a helix circuit positioned around the internal passage through the nozzle tip and arranged to accept the flow of a cooling fluid through the helix circuit;
wherein the flow path and the internal passage are colinear when the nozzle tip is secured to the main body;
wherein as cooling fluid flows through the helix circuit, heat from molten polymer in the internal passage of the nozzle tip is transferred to the cooling fluid such that the molten polymer in the internal passage of the nozzle tip will solidify.

9. The shut-off nozzle of claim 8, wherein when heat is transferred from the molten polymer in the internal passage of the nozzle tip to the cooling fluid flowing through the helix circuit, any molten polymer in the flow path proximate to the nozzle tip will solidify.

10. The shut-off nozzle of claim 9, wherein when molten polymer in the internal passage and flow path solidifies, the solidified polymer can be ejected from the shut-off nozzle as one continuous piece.

11. A method for forming a polymer part comprising the step:
providing an injection molding system with a shut-off nozzle, where the shut-off nozzle includes:
a main body comprising a flow path through the main body;
a nozzle tip secured to the main body, the nozzle tip comprising:
an internal passage through the nozzle tip, wherein the flow path and internal passage are colinear when the nozzle tip is secured to the main body; and
a cooling mechanism; and
a shut-off mechanism comprising:
a passageway intersecting the flow path at an angle to the flow path; and
a pin positioned in the passageway;
initiating an injection molding cycle by injecting molten polymer through the shut-off nozzle into a mold with a cavity until the cavity of the mold is filled with molten polymer;
actuating the shut-off mechanism to move the pin in the passageway into the intersection of the passageway and flow path, and
initiating the cooling mechanism to solidify molten polymer in the nozzle tip to form a solid slug.

12. The method of claim 11, further comprising:
cooling the molten polymer in the cavity of the mold to solidify the molten polymer in the cavity of the mold to form a part.

13. The method of claim 12, wherein, the steps of initiating the cooling mechanism to solidify molten polymer in the nozzle tip to form a solid slug and cooling the molten polymer in the cavity of the mold to solidify the molten polymer in the cavity of the mold to form a part occur at the same time.

14. The method of claim 13, wherein the cold slug and formed part are physically connected.

15. The method of claim 14, where the formed part and solid slug are ejected together from the injection molding system.
